(19) United States
(12) Patent Application Publication
(10) Pub. No.: US 2021/0238845 A1
(43) Pub. Date: Aug. 5, 2021

(54) MODULAR TEMPORARY CONTAINMENT SYSTEM

(71) Applicant: STARC Systems, Inc., Brunswick, ME (US)

(72) Inventors: Bruce BICKFORD, Cushing, ME (US); Timothy HEBERT, Yarmouth, ME (US)

(73) Assignee: STARC Systems, Inc., Brunswick, ME (US)

(21) Appl. No.: 17/155,747

(22) Filed: Jan. 22, 2021

Related U.S. Application Data
(60) Provisional application No. 62/969,288, filed on Feb. 3, 2020.

(51) Int. Cl. E04B 1/94; E04B 2/72; E04C 2/26; E04C 2/38; E04B 2/00; B32B 3/06; B32B 9/00; B32B 5/02; B32B 5/26; B32B 7/12

(52) U.S. Cl. CPC E04B 1/942; E04B 1/947; E04B 1/948; E04B 2/721; E04C 2/26; E04C 2/388; E04C 2002/004; B32B 3/06; B32B 9/005; B32B 5/02; B32B 5/26; B32B 7/12; E04C 2/46

(57) ABSTRACT

A barrier system for partitioning a space is formed by panels which interlock with each other to provide a barrier that is fire rated. The interlocking panels are assembled in the barrier in columns which include at least two panels. A first horizontal joint between two panels of the barrier in a first column is vertically offset from a horizontal joint between two panels of the barrier in a second column that is adjacent to the first column at a vertical joint. Each panel is made of a laminated structure including a supporting frame around a core layer, barrier layers on opposed surfaces of the core and skin layers on the barrier layers. Tongue and groove construction interlocks the panels and a locking structure formed by a tapered hook in the groove engaging into a slot of the tongue locks horizontally adjacent panels to each other.

### CROSS-REFERENCE TO RELATED APPLICATION

This application claims priority from U.S. Provisional Application for Patent No. 62/969,288, filed Feb. 3, 2020, the disclosure of which is incorporated by reference.

### TECHNICAL FIELD

The present invention generally relates to temporarily installed barriers for use in partitioning a space in construction and remodeling projects and, more particularly, to a system for temporary containment that provides a fire, smoke and sound barrier.

### BACKGROUND

During the construction or remodeling of a building interior it is often desirable to temporarily partition the space. In one conventional solution, a temporary barrier is constructed. The temporary barrier may be a soft barrier (such as a plastic sheet) or hard barrier (comprising a light duty wall constructed on site from wood or gypsum panels mounted to a frame which is attached to the walls, ceiling and floor). A further advancement in the art provides for the installation of a prefabricated barrier that is reusable following completion of the project. An example of this is described in U.S. Pat. No. 10,041,249 (incorporated herein by reference).

When a building is occupied and a remodel is being performed, it is conventional for building and fire code regulations to require the presence of a barrier between the occupied and remodel spaces that will provide for a level of fire and smoke protection (see, for example, ASTM E-84 and E-119 performance requirements). Providing this level of protection can be a challenge. There is a need in the art for a temporary rated protection barrier which is prefabricated and reusable.

### BRIEF DESCRIPTION OF THE DRAWINGS

For a better understanding of the embodiments, reference will now be made by way of example only to the accompanying figures in which:

FIGS. 1 and 2 each illustrate a section of a temporary barrier;

FIG. 3 shows an example of panel sizes for the barrier;

FIG. 4 is a perspective view of an example panel;

FIGS. 5A-5E are cross sectional views of panels and the interconnection of panels using a tongue and groove joint;

FIGS. 6A-6B are perspective views showing a locking mechanism provided with the tongue and groove joint between adjacent panels;

FIG. 6C illustrates a shape of the tapered hook of the locking mechanism;

FIGS. 7A-7B are perspective views of a floor track module for supporting panels of the barrier;

FIGS. 8A-8B are perspective views of a wall interface wall filler panel for supporting panels of the barrier;

FIGS. 9A-9B are perspective views of a wall filler panel for supporting panels of the barrier;

FIGS. 10A-10B are perspective views of a top of wall interface for supporting panels of the barrier;

FIGS. 11A-11B are perspective views of a corner connector for supporting panels of the barrier;

FIGS. 12A-12B are perspective views of specialized performance panels for the barrier; and

FIGS. 13A-13B are perspective views of a hinged door for the barrier.

### DETAILED DESCRIPTION

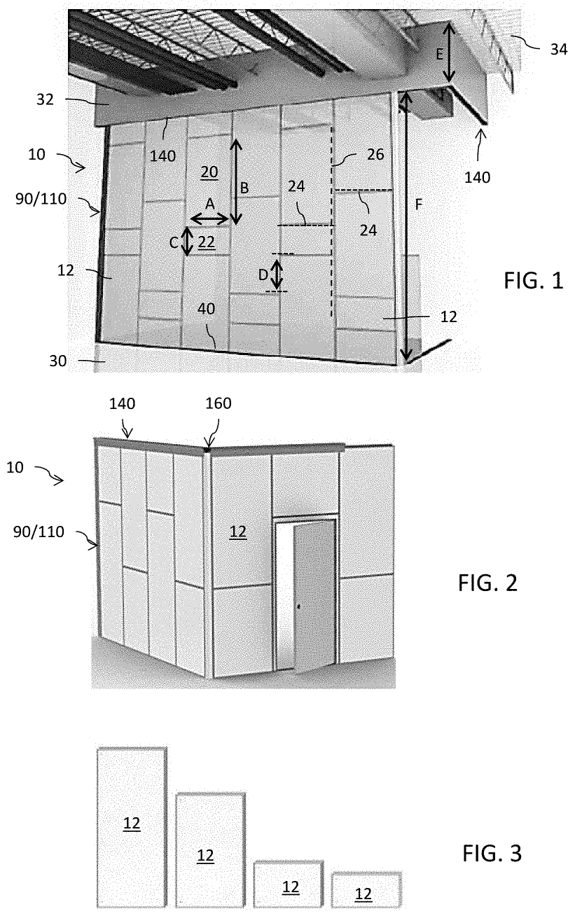

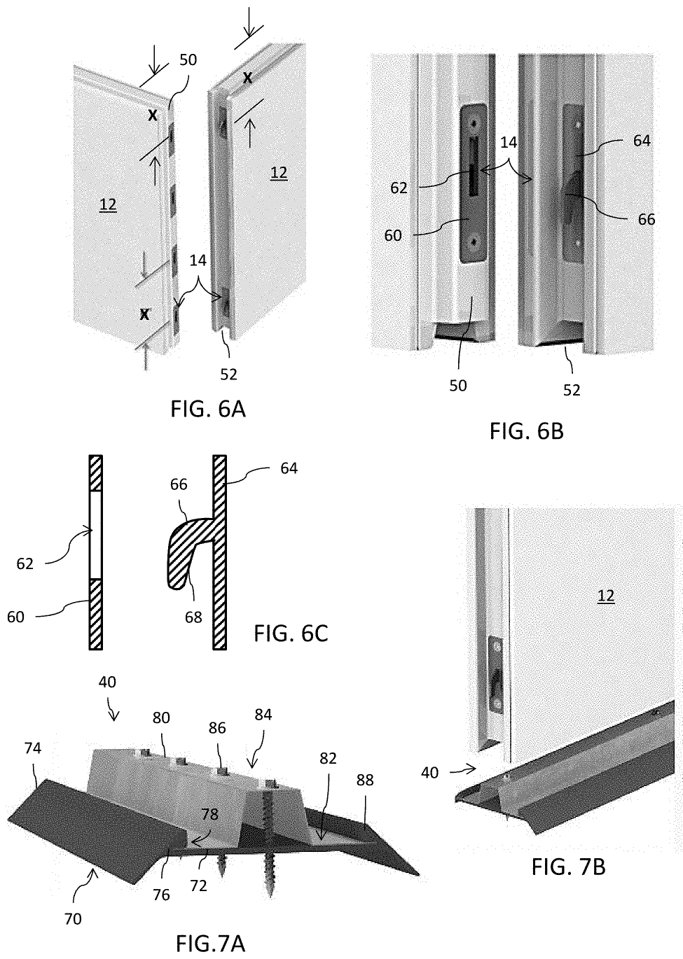

Reference is now made to FIGS. 1 and 2 which each illustrate a section of a temporary barrier 10. The barrier 10 is formed by a plurality of panels 12 which are interlocked with each other. Each panel 12 has a same thickness. The panels 12 are interlocked with each other using an interlocking mechanism. In an embodiment, the interlocking mechanism comprises a tongue and groove assembly (not shown in FIGS. 1-2, see FIG. 5A for example) and a locking mechanism 14 (not shown in FIGS. 1-2, see FIGS. 6A-6B). This is just one example, and other interlocking mechanisms could instead be utilized. The panels 12 can be provided in a number of different dimensions, with FIG. 1 showing by way of example two different dimensions: one panel 20 with a dimension A×B and another panel 22 with a dimension of A×C. FIG. 2 likewise shows an implementation using panels 12 of two distinct dimensional sizes. FIG. 3 shows by way of example a set of panels 12 with four different dimensional sizes (where the width of the illustrated panels can be selected from, for example, 18 inches, 24 inches and 36 inches; and where the heights of the four panels 12 are, for example from right to left, 18 inches, 24 inches, 60 inches and 84 inches). Installation of the panels 12 advantageously provides for vertically offset horizontal joints 24 with respect to two adjacent columns of panels sharing a common vertical joint 26. The minimum amount of spacing D between two horizontal joints 24 is dependent on the frame/panel stiffness, adhesive shear strength, core bending and other shear properties of the panels.

The barrier 10 is installed in the space between the floor 30 and a soffit 32 which is constructed under the floor deck (ceiling) 34. The configuration of the constructed soffit 32 accounts for the presence of structural, electrical, plumbing, heating, air conditioning and other equipment, and the depth E of the soffit 32 must take into account the dimensions B and C of the panels so that the bottom of the soffit can interface with a top of the top-most panel using an integer number of vertically stacked panels (of selected dimensional sizes) providing a height F.

The barrier 10 is designed to provide basic but complete functionality for a fire barrier system that meets, at the very least, ASTM E-84 and E-119 performance requirements. Additionally, the barrier 10 is designed to provide a smoke barrier and an Infection Control Risk Assessment (ICRA) negative pressure performance functionality.

The use of an interlocking panel-based assembly for the barrier 10 provides for maximum flexibility and adaptability to handle a wide range of installation conditions or situations as typically arise in order to meet the needs for containment of an interior space during renovation. This is accomplished through the provision of interlocking panels with varying dimensional sizes that can be specifically selected to meet the length and height requirements of the barrier for partitioning off the space.

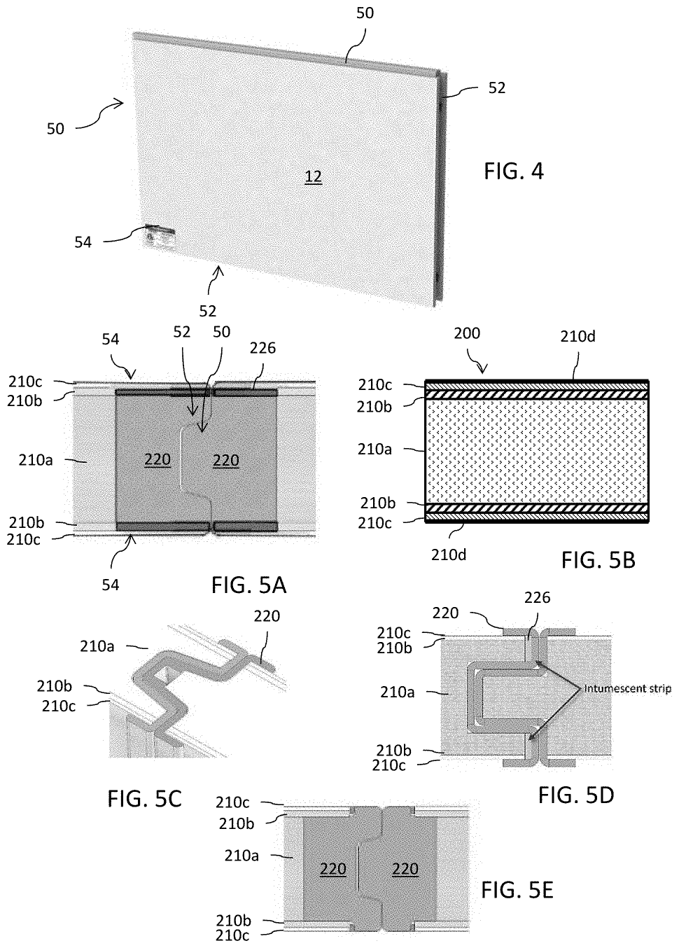

FIG. 4 shows more detail of an embodiment of the panel 12. The peripheral edge of each panel is provided with a tongue and groove configuration which also supports interlocking (to be described, see FIGS. 6A-6B). As an example, two adjacent side edges (top and left edges of a pair of adjacent edges in the illustration) are provided with tongues 50 and the opposite two adjacent side edges (right and bottom edges of another, opposed, pair of adjacent edges in the illustration) are provided with grooves 52. The interlocking tongue and groove configuration (with a cross section as shown in FIG. 5A) of the panels supports the provision of airtight joints as well as minimizes the seam between adjacent panels. The panels are symmetrical in design with both side faces 54 being the same, and configured to be clean/cleanable. The panels 12 provide fire rated protection and further provide for sound attenuation.

Adjacent panels 12 are locked to each other using a locking mechanism 14 provided in the form of mounted hardware as shown in FIGS. 6A-6B. The locking mechanism includes a plate 60 mounted to the tongue 50, where the plate includes a slot opening 62. The locking mechanism further includes a plate 64 mounted to the groove 52, where the plate includes a tapered hook 66 extending perpendicularly from the plate. The general shape of the tapered hook 66 is shown in FIG. 6C where hook 66 includes a proximal portion connected to and extending perpendicularly from the plate 64 and a distal portion extending perpendicular from the proximal portion and having a width in the illustrated view that gradually decreases from the proximal portion to the distal end to define a sloped interior surface 68 that engages with plate 60 (after passing through the slot opening 62). To lock one panel to another panel, a lift and drop construction is supported where the tongue 50 of one panel is inserted into the groove of another panel with the tapered hook 66 aligned and partially inserted into the slot opening 62. The one panel is then dropped into place with the tapered hook 66 engaging the back of the plate 60 to draw the panels into tight interlock. The general shape of the tapered hook 66 is shown in FIG. 6C where hook 66 includes a proximal portion connected to and extending perpendicularly from the plate 64 and a distal portion extending perpendicular from the proximal portion and having a width in the illustrated view that gradually decreases from the proximal portion to the distal end to define a sloped interior surface 68 that engages with plate 60 (after passing through the slot opening 62). The taper lock is provided in both directions for stability (i.e., both in the vertical joints and in the horizontal joints). The tapered connection serves to add stiffness to the vertical column assembly when tightened by the tapered hook and slot mechanism. The tapered connection is thus considered to be in two distinct planes, both parallel to the floor (frame tongue and groove), and parallel to the wall plane. The resulting interlocked assembly therefore increases stiffness, hence stability, in a vertical plane normal to the wall. The tongue and groove engagement of the panels 12 along with the tapered hook and slot interlock produces a tight lock between panels that supports ICRA Class IV performance of the barrier 10.

To support the staggering of the joints as discussed above, the tongues 50 of panels 12 are provided with more plates 60 having slot openings 62 than the grooves 52 are provided with plates 64 having tapered hooks 66. The provision of more plates 60 having slot openings 62 also supports multiple points of attachment for height diversity (see, FIG. 3) of the panels 12. As an example, shown in FIG. 6A, there are four plates 60 having slot openings 62 in the tongues 50 and two plates 64 having tapered hooks 66 with respect to adjacent panels. In an example construction of adjacent panels, the alignment as shown in FIG. 6A would have the two plates 64 having tapered hooks 66 for the right panel engage the top most and bottom most plates 60 having slot openings 62 of the left panel, and in this case the horizontal 24 joints would not be staggered. To implement a staggering of the horizontal joints 24, the lower plate 64 having a tapered hook 66 of the right panel would engage one of the plates 60 having slot openings 62 in the left panel shown, and the upper plate 64 having a tapered hook 66 would engage one of the plates 60 having slot openings 62 in another panel (not shown) which is installed above the left panel. The separation X between plates 60 having slot openings 62 is the same along the length of the tongue 50 of all panels and the separation X is also the same between the top/bottom plate 60 having a slot opening 62 in one panel and the corresponding bottom/top plate 60 having a slot opening 62 in the vertically adjacent panel of a column of panels. Likewise, the same separation X is provided between the top/bottom plate 64 having the tapered hook 66 in one panel and the corresponding bottom/top plate 64 having the tapered hook 66 in the vertically adjacent panel.

The panels 12 rest on a floor track module 40 (see also FIGS. 7A-7B) which provides a stable mounting element for the stacked panels. The floor track module 40 includes a rubber gasket 70 that not only provides a sealing function but also inhibits sliding or lateral movement of the panels after installation (this being especially beneficial in cases where the floor track module 40 cannot be fixed to the floor). The gasket 70 includes a base 72 from which a downwardly angled sealing strip 74 extends from a longitudinal edge 76. The sealing strips 74 are provided along opposed longitudinal edges 76 of the base 72. The gasket is secured to a bracket 80 having flanges 82 which extend from opposite longitudinal sides of a base member 84. Each flange 82 engages with a slot 78 in an upper surface of the gasket adjacent the location of the longitudinal edge 76. The base member 84 has a cross sectional U-shape (up-side-down oriented) which is structurally resilient against bending in order to provide a flat (and level) support surface for the panels 12. Screws 86 may be used where permitted to secure the floor track module 40 to the underlying floor of the space. Tightening of the screws and/or the weight of the panels compresses downwardly angled sealing strips 74 so that the outer edge of each strip conforms against the underlying floor to provide a floor seal (even in the case where there is an unevenness of or variance in the floor surface). As a result, an ICRA Class IV airtight connection is made to the floor. A compressible body 88 is provided at the upper surface of the base 72 extending along each longitudinal edge 76 (and which may define the slot 78). The seal with the panels is provided by giving the base member 84 a tongue (or hat) shape to engage with the groove in the bottom on the panel 12 and further having the bottom edge of the panel engage against the compressible body 88.

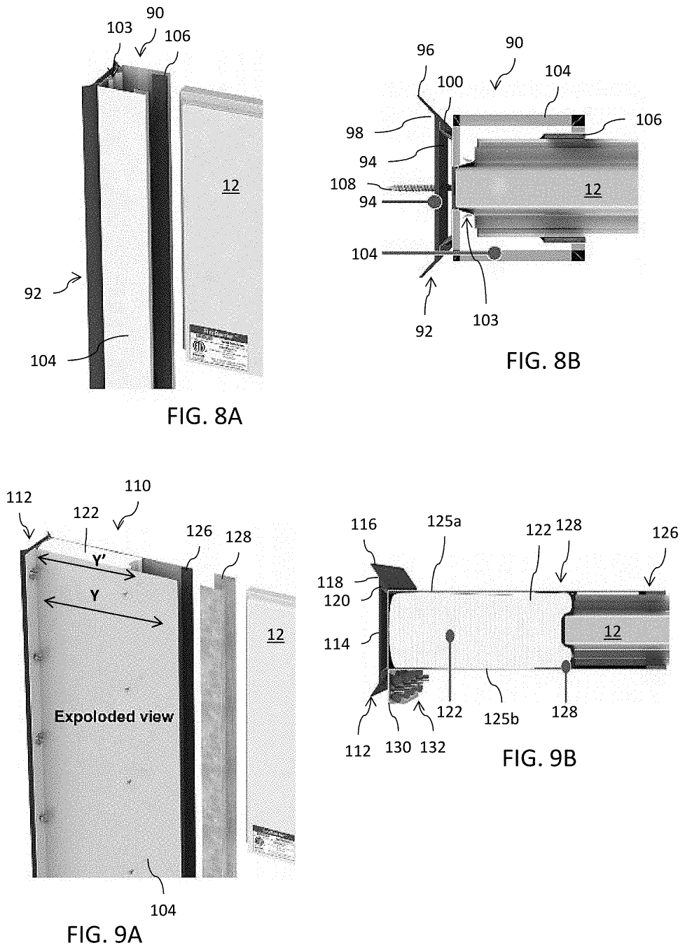

The attachment of the barrier 10 to the existing wall of the space is made through a wall interface 90 as shown in FIGS. 8A-8B. The wall interface 90 includes a rubber gasket 92 that provides a sealing function against the existing wall. The gasket 92 includes a base 94 from which a downwardly angled sealing strip 96 extends from a longitudinal edge 98. The sealing strips 96 are provided along the opposed longitudinal edges 98 of the base 94. A compressible body 100 is provided at the upper surface of the base 94 extending along each longitudinal edge 98. A guide channel 104 is formed of a base member and two opposed side members which define an open end. The open end is sized and shaped to receive a panel 12 (this advantageously supports wall interconnect even in situations where the wall is not plumb). Inside surfaces of the two opposed side members include a sealing material 106 which seals against the opposed faces of the panel 12. The base member of the guide channel 104 includes a groove section 103 that is configured to receive the tongue 50 of the wall panel 12. Screws 108 may be used to secure the wall interface 90 to the existing wall. The screws 108 pass through the base member of the guide channel 104 and the base 94 (at the location of the groove section 103). Tightening of the screws compresses the downwardly angled sealing strips 96 so that the outer edge of each strip conforms against the existing wall to provide a wall seal and further compresses the compressible body 100 to the base member of the guide channel 104. The combination of the downwardly angled sealing strips, the compressed compressible body 100 and the sealing material 106 produces an ICRA Class IV airtight connection to the wall.

It may also be necessary, considering the size of the partitioned space, to include an on-site constructed stub wall adjoining existing walls in order to laterally connect with the barrier 10. In a preferred implementation, however, the barrier 10 further includes a wall filler panel 110 as shown in FIGS. 9A-9B for attaching the barrier 10 to the existing wall. The wall filler panel 110 includes a rubber gasket 112 that provides a sealing function against the existing wall. The gasket 112 includes a base 114 from which a downwardly angled sealing strip 116 extend from a longitudinal edge 118. The sealing strips 116 are provided along the opposed longitudinal edges 118 of the base 114. A compressible body 120 is provided at the upper surface of the base 114 extending along each longitudinal edge 118. A channel 124 is formed by two interconnected L-shaped brackets 125a and 125b with the bases of the L-shaped brackets being placed in contact to form a base member and the legs of the L-shaped bracket being spaced apart to form two opposed side members which define an open end. The open end is filled with a fire and sound inhibiting material 122 such as mineral wool. A lock channel 128 is inserted in the open end to contain the material 122 and further provides a groove that is sized and shaped to receive the tongue of a panel 12. It will be noted that the lock channel 128 can be installed in opposite orientations (tongue facing in or groove facing in) so as to accommodate wall interface to either tongue/groove panel edge. The interface between the tongue and groove serves to provide a lock between the faces which ensures an air and smoke tight seal against the panel. Inside surfaces of the two opposed side members may include a thermally expanding sealing material 126 which seals against the opposed faces of the panel 12. An example of such a thermally expanding sealing material is an intumescent material. The overlapping bases 125c of the L-shaped brackets form a flange 130. Screws 132 at the flange 130 may be used to secure the base of bracket 125b to the base of bracket 125a. The legs of the L-shaped brackets are secured to the lock channel 128 using screws (not explicitly shown) in the field installation to customize the side of the wall interface. Panel installation presses against the lock channel 128 which pushes the wall filler panel 110 towards the wall and compresses the downwardly angled sealing strips 116 so that the outer edge of each strip conforms against the existing wall to provide a wall seal and further compresses the compressible body 120 to the base member of the channel 124. The combination of the downwardly angled sealing strips, the compressed compressible body 120, the material 122 and the sealing material 126 produces an ICRA Class IV airtight connection to the wall. The width Y of the two opposed side members is selected to provide a range of installation widths supported by the wall filler panel 110. The amount of fill material 122 along with the positioning of the lock channel 128 in the open end sets the effective width Y′ of the wall filler panel 110.

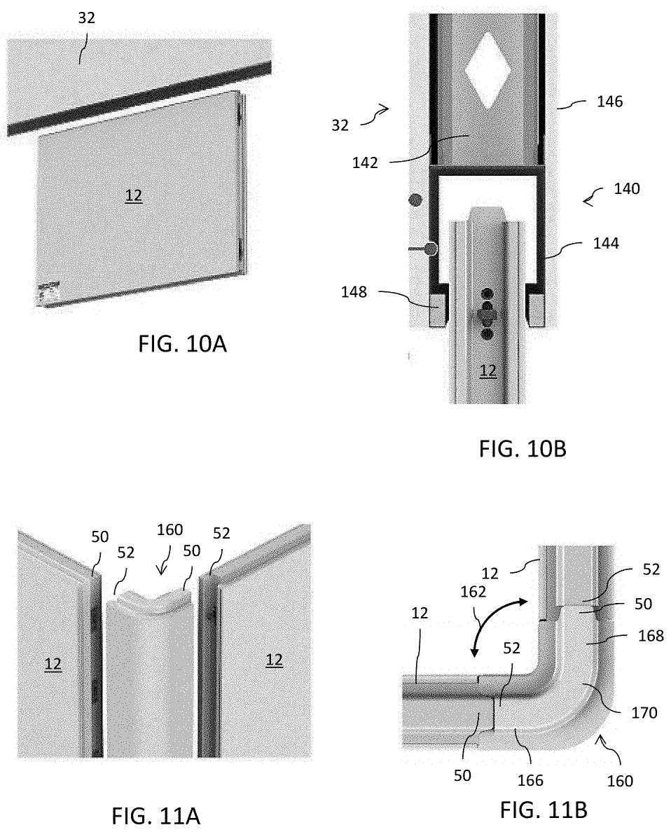

The seal of the barrier 10 to the soffit 32 is provided through a top of wall interface 140 as shown in FIGS. 10A-10B. The soffit 32 is constructed as a rated barrier using conventional construction techniques and materials and will include a vertical stud member 142 mounted to a horizontally extending channel 144 that is formed of a base member and two opposed side members which define an open end. The sides of the vertical stud member 140 and the sides of the channel 144 are covered by wallboard material 146. The channel 144 serves to support and restrain the wall transversely during a fire event, as the outer wallboard material 146 could burn away in response to exposure to the fire. The open end is sized and shaped to receive a panel 12. Inside surfaces of the two opposed side members include a thermally expanding sealing material 148 which seals against the opposed faces of the panel 12. An example of such a thermally expanding sealing material is an intumescent material. The sealing material 148 further produces an ICRA Class IV airtight connection to the soffit 32 wall. The slip fit of the panel 12 into the channel 144 permits a fast installation and accommodates height variances.

The accommodate change in direction of the barrier when partitioning a space, the barrier 10 further includes a corner connector 160 as shown in FIGS. 11A-11B. The angle 162 defined by the corner connector 160 is shown in the illustration as 90°, but it will be understood that the corner connector 160 can be made with any fixed selected angle (for example, 45° and 135°). The corner connector 160 is formed by a first leg portion 166 and second leg portion 168 which are coupled to each other through an angle transition portion 170 whose configuration defines the angle 162. The corner connector 160 is constructed in a same way as the panels 12 and supports interconnection with the same tongue and groove configuration. For example, the first leg portion 166 includes the groove 52 and the second leg portion 168 includes the tongue 50. It will further be understood that the tongue 50 of the second leg portion 168 includes the plates 60 having slot openings 62 and the groove 52 of the first leg portion 166 includes the plates 64 having tapered hooks 66 (see, FIGS. 6A-6B). The tongue and groove engagement of the panel 12 to the corner connector 160 along with the tapered hook and slot interlock produces a tight lock between the panel and the corner connector 160 that supports ICRA Class IV performance of the barrier 10. The corner connector 160 will be made of varying heights conforming to the heights of the panels (see, for example, FIG. 4).

The panels 12 and corner connectors 160 are made of a composite system designed to meet ASTM E-119 requirements. In particular, the wall made of the panels 12 and corner connectors 160 is designed to withstand exposure to a temperature profile reaching 1,700° F. followed by a fire hose test. Each panel/corner connector structure is made of a lamination 200 that functions to reflect, absorb and conduct heat from the fire in a controlled manner, resulting in a gradual temperature rise of the cool side of the panel/corner connector structure over the duration of the fire. An important feature of the lamination 200 is the selective use of layers to delay the thermal wave through the core. The multiple interfaces between material layers as well as the individual thermal conductivity values of those material layers cumulatively reduce the rate of conductivity.

The lamination 200 for the panel/corner connector structure is formed of a plurality of layers 210. In an embodiment, five layers are used comprising a core layer 210a, two barrier layers 201b on opposite sides of the core layer 210a and two outer skin layers 210c (where each barrier layer 210b is positioned between the core layer 210a and a corresponding one of the outer skin layers 210c). A cross sectional view of the lamination 200 is shown in FIG. 5B. The core layer 210a may, for example, be made of a material selected from the group consisting of: Fabrock 60, Fabrock HD, Fabrock 120, Zircal 18, Tenmat, OC Foamglass, Armil Super-Isol, Armil FBX 1900, Balsa and MAM WDS Ulta (with a thickness in a range of 1 to 2 inches). The barrier layer 210b may, for example, be made Superwool or aluminum (with a thickness in a range of 0.125 to 0.25 inches). The outer skin layer 210c may, for example, be made of a material selected from the group consisting of: TFP/Phenolic resin, TFP VIP Phenolic resin, Phenolic FRP and Vixen FRP (with a thickness of about 0.125 inches) or galvanized steel (with a thickness of about 26 ga). The outer surfaces of the outer skin layer 210c may further be coated with a coating material 210d made, for example, of a material selected from the group consisting of: SW FX5090, Firewall 16 and TPR2.

In one preferred implementation, the lamination 200 includes a core layer 210a made of Armil Super-Isol (calcium silicate ceramic board) with a thickness of 2 inches, two barrier layers 210b each made of Morgan Advanced Materials (MAM) superwool with a thickness of 0.125 inches and two outer skin layers 210c made of Vixen FRP with a thickness of 1.5-1.8 mm. The surfaces of the materials forming the lamination 200 are adhered to each other using an adhesive material (such as Thermo-o-stix (with a strong ammonia solvent) or a urethane adhesive such as Gorilla Glue).

Each panel/corner connector structure is supported by a peripheral frame 220 (see, for example, FIGS. 5A and 5C-5E) that stiffens the edges and provides a foundation for the attachment of the hardware used for interlocking. The frame 220 has a thickness which may, in a preferred implementation, be equal to the thickness of the core layer 210a. In this implementation, the frame 220 surrounds the core layer 210a and functions seal and protect the perimeter of the core layer 210a. In a preferred implementation, the rails of the frame 220 are adhesively bonded to the outer peripheral surface of the core layer 210a and are attached to each other at the corners using an adhesive and/or a mechanical bracket fastener. This bonding serves to thermally connect the frame to the core so as to more readily transfer thermal energy from the frame to the core. In this context, the core advantageously functions as a form of a heat sink to draw heat away from the frame. The barrier layers 210b and the outer skin layers 210c extend beyond the perimeter of the core layer 210a, to the perimeter edge of the panel/corner connector structure at the groove edges and to the start of the tongue for the tongue edges. The frame 220 can thus also provide some protection to the outer peripheral edges of the barrier layers 210b and outer skin layers 210c. The outer peripheral edge of the frame 220 further defines the tongue and groove structures which support mechanical connection between panels/corner connector structures. The frame 220 further serves as a thermal barrier at the location of joints between panel/corner connector structures.

In one embodiment, the frame 220 is made of a fiber reinforced phenolic resin material that is pultruded into the desired shapes for making the rail members of the frame. See, FIG. 5C. This material provides excellent high temperature performance, mechanical strength and support for the tongue and groove designs.

In another embodiment, the frame 220 is made of a polycarbonate material that is extruded into the desired shapes for making the rail members of the frame. See, FIG. 5D. In this implementation, an intumescent strip 226 is placed adjacent to the outer surfaces (for example, underneath each outer skin layer 210c). The advantage of utilizing the intumescent strip 226 in this implementation is that when the polycarbonate material of the frame 220 begins to melt or burn in response exposure to high temperature the intumescent strip 226 will swell to fill the gap and provide an insulating joint that also prevents penetration of smoke and flame.

In yet another embodiment, the frame 220 is made of a natural wood material (such as Red Balau) that is milled into the desired shapes for making the rail members of the frame. See, FIGS. 5A and 5E. In this implementation, an intumescent strip 226 is placed adjacent to the outer surfaces (for example, underneath each outer skin layer 210c). The advantage of utilizing the intumescent strip 226 in this implementation is that when the wood material of the frame 220 burns in response exposure to high temperature the intumescent strip 226 will swell to fill the gap and provide an insulating joint that also prevents penetration of smoke and flame. To provide for additional protection, the exposed surfaces of the wood frame 220 at the tongues and grooves are painted with an intumescent paint that limits burn rate during the fire event.

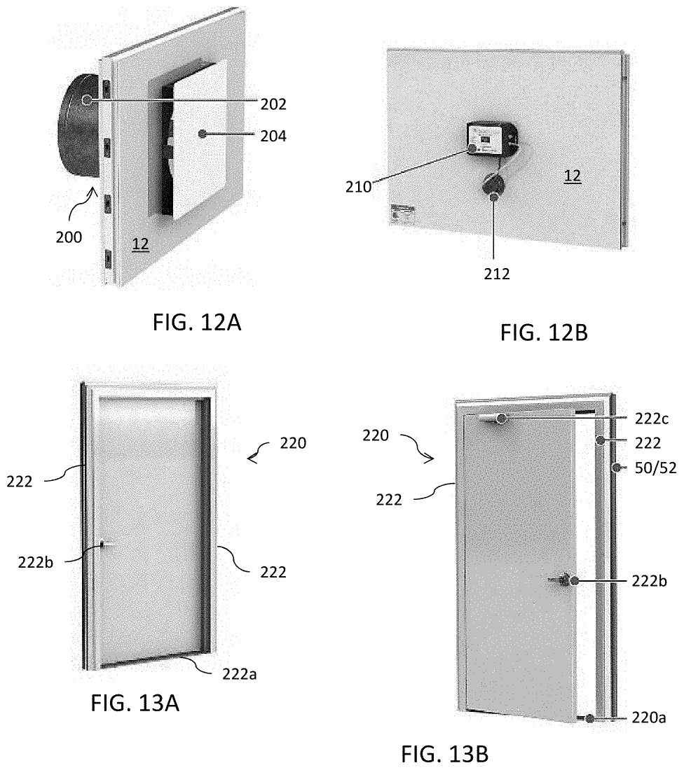

The barrier 10 may further be constructed to include specialized performance panels as shown in FIGS. 12A and 12B. More specifically, FIG. 12A shows a specialized performance panel which includes an air discharge mechanism 200. An opening (not explicitly shown) passes through the panel 12 from one face to the opposite face. An ICRA Class IV fire and fire and smoke dampener 202 is mounted on one face and an air diffuser 204 is coupled to the smoke dampener through the opening and mounted on the opposite face. The air discharge mechanism 200 assists in providing the required negative pressure performance functionality with respect to the partitioned space by allowing an exhaust air discharge point in the barrier wall to the public side of the barrier. A negative air machine with HEPA filtration is commonly used to exhaust through this discharge port. The smoke damper has an integral fusible link to automatically close the duct passage upon reaching a (low) predetermined temperature. FIG. 12B shows a specialized performance panel which includes an environmental monitoring mechanism 210. The environmental monitoring mechanism 210 may be a multisensor module which operates to sense one or more of differential pressure, particulate presence (multiple sizes), temperature, humidity, sound level and carbon dioxide. Alternatively, the mechanism 210 may be of simpler functionality to, for example, measure differential pressure between the occupied and container spaces. The data collected by the environmental monitoring mechanism 210 can be wirelessly communicated (using WiFi or cellular communications). A wiring pass through 212 is provided to enable data to be passed by a wired connection through the panel.

The configuration of the panels 12 for the barrier permits the design of an opening that is sized and shaped to receive a hinged door 220 as shown in FIGS. 13A-13B. The support interconnection with the panels, the frame 222 of the door 220 is provided with the same tongue and groove structure where the tongue 50 includes the plates 60 having slot openings 62 and the groove 52 includes the plates 64 having tapered hooks 66 (see, FIGS. 6A-6B). The threshold 220a of the door 220 is further configured to engage the floor track module 40 (see also FIGS. 7A-7B) and a door latch 222b and closure assist mechanism 222c are provided to secure the door operation. Conventional panels of width corresponding to the door frame width are installed above the door to complete the wall section of the barrier.

While the invention has been illustrated and described in detail in the drawings and foregoing description, such illustration and description are considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

What is claimed is:

1. A barrier system for partitioning a space, comprising:
a plurality of interlocking panels forming a barrier that is fire rated;
wherein the interlocking panels are assembled in the barrier in columns which include at least two panels; and
wherein a first horizontal joint between two interlocking panels of the barrier in a first column is vertically offset from a horizontal joint between two interlocking panels of the barrier in a second column that is adjacent to the first column at a vertical joint.

2. The barrier system of claim 1, wherein each interlocking panel includes four side edges and wherein a first pair of adjacent side edges of the panel each include a tongue for supporting the interlocking between the interlocking panels and wherein a second pair of adjacent side edges of the interlocking panel each include a groove for supporting the interlocking between the interlocking panels.

3. The barrier system of claim 2, further comprising a first plate with an opening that is mounted to each tongue and a second plate with a tapered hook that is mounted to each groove, and wherein the tapered hook is configured for insertion and retention in the opening to lock adjacent panels at the vertical joint to each other.

4. The barrier system of claim 2, where the tongue is sized and shaped to engage the groove to form a seal between adjacent interlocking panels.

5. The barrier system of claim 1, wherein the two interlocking panels of the barrier in the first column have a same width but different heights.

6. The barrier system of claim 1, wherein the two interlocking panels of the barrier in the first column have a same width and a same height.

7. The barrier system of claim 1, wherein each interlocking panel comprises:
a peripheral frame having four side edges and wherein a first pair of adjacent side edges of the peripheral frame each include a tongue for supporting the interlocking between the interlocking panels and wherein a second pair of adjacent side edges of the peripheral frame each include a groove for supporting the interlocking between the interlocking panels;
a core layer surrounded by the peripheral frame;
a barrier layer mounted to each of a first and second opposed surfaces of the core layer; and
a skin layer to an outer surface of each barrier layer.

8. The barrier system of claim 7, wherein the peripheral frame is made of a material selected from the group consisting of: a fiber reinforced phenolic resin material, a polycarbonate material and a natural wood material.

9. The barrier system of claim 7, wherein the core layer is made of a material selected from the group consisting of: Fabrock 60, Fabrock HD, Fabrock 120, Zircal 18, Tenmat, OC Foamglass, Armil Super-Isol, Armil FBX 1900, Balsa and MAM WDS Ulta.

10. The barrier system of claim 7, wherein the barrier layer is made of a superwool material or an aluminum material.

11. The barrier system of claim 7, wherein the skin layer is made of a material selected from the group consisting of: TFP/Phenolic resin, TFP VIP Phenolic resin, Phenolic FRP, Vixen FRP and galvanized steel.

12. The barrier system of claim 7, further comprising an intumescent strip positioned between the skin layer and the frame.

13. The barrier system of claim 7, further comprising an intumescent strip positioned between the core and the frame.

14. The barrier system of claim 1, wherein the space includes a floor and further comprising a floor track module which includes a flexible seal against the floor and a channel configured to receive an interlocking panel.

15. The barrier system of claim 14, further comprising a sealing material mounted to an inner surface of the channel and configured to seal against an outer surface of the received interlocking panel.

16. The barrier system of claim 15, wherein the sealing material is intumescent.

17. The barrier system of claim 1, wherein the space includes a wall and further comprising a wall interface module which includes a flexible seal against the wall and a channel configured to receive an interlocking panel.

18. The barrier system of claim 17, further comprising a sealing material mounted to an inner surface of the channel and configured to seal against an outer surface of the received interlocking panel.

19. The barrier system of claim 17, wherein the sealing material is intumescent.

20. The barrier system of claim 17, further comprising a filling material filling an interior space of the channel adjacent an edge of the received interlocking panel.

21. The barrier system of claim 17, further comprising a lock channel that is configured to be received within and secured to an interior space of the channel and which further includes means for interlocking to the received interlocking panel.

22. The barrier system of claim 1, further including a corner module configured to interlock with the interlocking panel.

23. The barrier system of claim 1, wherein the space includes a soffit and further comprising a soffit interface module which includes a channel configured to receive an interlocking panel.

24. The barrier system of claim 23, further comprising a sealing material mounted to an inner surface of the channel and configured to seal against an outer surface of the received interlocking panel.

25. The barrier system of claim 24, wherein the sealing material is intumescent.

26. The barrier system of claim 1, further comprising an environmental monitoring mechanism mounted to at least one of the interlocking panels.

27. The barrier system of claim 1, further comprising a fire and smoke dampener mounted to at least one of the interlocking panels.

28. An interlocking panel of a temporary barrier system, comprising:
a lamination of a plurality of layers including:
a core layer;
a first barrier layer on one side of the core layer;
a second barrier layer on an opposite side of the core layer;
a first outer skin layer on the first barrier layer; and
a second outer skin layer on the second barrier layer.

29. The interlocking panel of claim 28, wherein the core layer is made of a material selected from the group consisting of: Fabrock 60, Fabrock HD, Fabrock 120, Zircal 18, Tenmat, OC Foamglass, Armil Super-Isol, Armil FBX 1900, Balsa and MAM WDS Ulta.

30. The interlocking panel of claim 28, wherein each of the first and second barrier layers is made of a superwool material or an aluminum material.

31. The interlocking panel of claim 28, wherein each of the first and second outer skin layers is made of a material selected from the group consisting of: TFP/Phenolic resin, TFP VIP Phenolic resin, Phenolic FRP, Vixen FRP and galvanized steel.

32. The interlocking panel of claim 28, further comprising a coating layer on an outer surface of each of the first and second outer skin layers.

33. The interlocking panel of claim 28, further comprising an adhesive material for adhering the plurality of layers of the lamination to each other.

34. The interlocking panel of claim 28, further comprising a peripheral frame surrounding the plurality of layers of the lamination and having four side edges and wherein a first pair of adjacent side edges of the peripheral frame each include a tongue for supporting an interlocking between interlocking panels and wherein a second pair of adjacent side edges of the peripheral frame each include a groove for supporting the interlocking between interlocking panels.

35. The interlocking panel of claim 34, wherein the peripheral frame is made of a material selected from the group consisting of: a fiber reinforced phenolic resin material, a polycarbonate material and a natural wood material.

36. The interlocking panel of claim 34, further comprising:
a first plate with an opening that is mounted to each tongue; and
a second plate with a tapered hook that is mounted to each groove; and
wherein each opening is configured to receive a tapered hook and each tapered hook is configured to each an opening.
